(19) United States
(12) Patent Application Publication
(10) Pub. No.: US 2007/0140543 A1
(43) Pub. Date: Jun. 21, 2007

(54) Systems and methods for enhanced cytological specimen review

(75) Inventors: Peter D'Errico, South Walpole, MA (US); James Linder, Acton, MA (US); Kam Lin Wong, Bedford, MA (US); Peter Albany, Groton, MA (US); David Zahniser, Wellesley, MA (US)

Correspondence Address: VISTA IP LAW GROUP LLP, 12930 Saratoga Avenue, Suite D-2, Saratoga, CA, 95070, US

(73) Assignee: Cytyc Corporation, Marlborough, MA (US)

(21) Appl. No.: 11/311,973

(22) Filed: Dec. 19, 2005

(51) Int. Cl. G06K 9/00

(52) U.S. Cl. 382/133

(57) ABSTRACT

A system for prescreening and reviewing cytological specimens includes an imager for obtaining and processing image data of a specimen slide, which identifies cellular objects of interest in the specimen, calculates object values for the identified objects based on one or more of their respective physical attributes, and selects fields of view of the specimen slide for subsequent review on a review scope, based on the locations of identified objects having object values of greatest relative interest. One or more of the objects may be further selected by the imager for emphasized review, which may include additional presentation for review (whether automatic or conditioned) of the one or more objects, whether in the same or in a different field of view than when the object(s) were originally presented. Emphasized review of selected objects may also or additionally be provided by highlighting or otherwise visually emphasizing the objects when they are presented for viewing on the review scope.

### FIELD OF INVENTION

The present invention pertains generally to systems and methods for prescreening and reviewing cytological specimens fixed to specimen slides.

### BACKGROUND

Commercial cytological imaging and review systems are used to assist human evaluation of cytological specimens, e.g., a cervical cell sample fixed on a specimen slide. One such system is the Thin Prep Imaging System, manufactured and distributed by Cytyc Corporation (www.cytyc.com), which employs image processing technology to isolate cellular objects in a cytological specimen slide, and identify a fixed number of regions, or “fields of view,” on the specimen slide that contain cellular objects of interest for review by a cytotechnologist. Because the fields of view are prescreened, the cytotechnologist is more likely to recognize abnormal or potentially abnormal cellular objects in the specimen slides.

Despite the prescreening and selection of the fields of view for each specimen slide, studies have shown that the reviewing cytotechnologists will occasionally characterize a specimen slide as “normal,” even though at least a portion of the cellular objects of interest in the presented fields of view have an appearance that should have caused the cytotechnologist to characterize the slide at least as “suspicious,” if not abnormal, and requiring further review. Thus, improved techniques for cytological imaging and review systems that help reduce the chances of such “false negatives” occurring during the specimen slide review process would be highly desirable.

### SUMMARY OF THE INVENTION

Embodiments of the invention include systems and methods for prescreening and reviewing cytological specimens. In one embodiment, a system for prescreening and reviewing cytological specimens includes an imager for obtaining and processing image data of a specimen slide. In particular, the imager identifies (from the image data) cellular objects of interest in the specimen, and calculates object values for the identified objects based on one or more of their respective physical attributes, such as shape, size, texture, contrast, nuclear integrated optical density, and nuclear average optical density. The imager then selects fields of view of the specimen slide for subsequent review on a review scope, based on the locations of identified objects having object values of greatest relative interest.

One or more of the objects may be further selected by the imager for emphasized review, which may take the form, for example, of an additional presentation on the review scope of an object, whether in the same or in a different field of view than when the object was originally presented, wherein such additional presentation may be automatic or conditioned. For example, objects selected for emphasized review may be presented for additional review only if no objects were marked for subsequent analysis during an initial review of the specimen slide, or only if a measured attribute of the specimen indicates an above-average likelihood of the presence of abnormal or suspicious cells. Alternatively and/or additionally, such emphasized review of selected objects may be provided by highlighting or otherwise visually emphasizing the objects when they are presented for viewing on the review scope. By way of one example, the review scope may increase the magnification of objects to be emphasized.

By way of non-limiting example, objects selected for emphasized review may be those objects in the specimen, if any, having object values indicative of a greater than average likelihood cellular abnormality based on statistical information derived from a general population with respect to the physical characteristic(s) upon which the object values were calculated. Additionally or alternatively, objects selected for emphasized review may be those objects having object values falling in a top percentage (e.g., top 2-3%), or number (e.g., the top 2-3) of object values for the particular specimen.

In another embodiment, a system for prescreening and reviewing cytological specimens includes an imager for obtaining and processing image data of a specimen slide. In particular, the imager identifies (from the image data) cellular objects of interest in the specimen, and calculates object values for the identified objects based on one or more of their respective physical attributes, such as shape, size, texture, contrast, nuclear integrated optical density, and nuclear average optical density. The imager further measures, based on the image data, one or more attributes of the specimen that are associated with a likelihood of cellular abnormality in a general population. If any of the one or more measured attributes are within a range indicating an above-average likelihood of the presence of abnormal or suspect cells, the imager selects a relatively high number of objects and/or fields of view for review on the review scope. However, if none of the one or more measured attributes are within such range, the imager selects a lower number of objects and/or fields of view for review. In embodiments where more than one specimen attribute is measured, a weighed specimen score may be calculated and compared against a range of such possible weighted scores to determine how many objects and/or fields of view to present for review on the review scope. Whatever their number, the imager selects the fields of view based on the relative object values of objects located in therein, wherein one or more of the objects may also be selected for emphasized review.

By way of non-limiting examples, the measured specimen attribute(s) may include a relative presence of blood cells, opacity of the specimen slide or a region thereof, a relative presence of cells having a predetermined nuclear integrated optical density, such as one that is substantially greater than a mean nuclear integrated optical density, or of a standard deviation of a distribution of the nuclear integrated optical densities for identified cellular objects in the specimen. In one embodiment, at least one of the one or more measured attributes is a relative presence of cells in the specimen having physical attributes indicating an above average likelihood of cellular abnormality in a general population, wherein the attributes are selected from the group comprising shape, size, texture, contrast, nuclear integrated optical density, and nuclear average optical density. In another embodiment, at least one of the one or more measured attributes is a relative presence of identified cellular objects in the specimen having object values indicating an above average likelihood of cellular abnormality in a general population.

In a still further embodiment, a method for prescreening and reviewing cytological specimens includes obtaining and processing image data of a specimen slide in order to identify cellular objects of interest in the specimen, and calculate object values for the identified objects based on one or more of their respective physical attributes, such as shape, size, texture, contrast, nuclear integrated optical density, and nuclear average optical density. The method further includes selecting fields of view of the specimen slide for subsequent review on a review scope, based on the locations of identified objects having object values of greatest relative interest, with one or more of the identified objects being further selected for emphasized review. The emphasized review may include, for example, an additional presentation on the review scope of an object, whether in the same or in a different field of view than when the object was originally presented, wherein such additional presentation may be automatic or conditioned. For example, objects selected for emphasized review may be presented for additional review only if no objects were marked for subsequent analysis during an initial review of the specimen slide, or only if a measured attribute of the specimen indicates an above-average likelihood of the presence of abnormal or suspicious cells. Alternatively and/or additionally, such emphasized review of selected objects may be provided by highlighting or otherwise visually emphasizing the objects when they are presented for viewing on the review scope. By way of one example, the review scope may increase the magnification of objects to be emphasized.

By way of non-limiting example, objects selected for emphasized review may be those objects in the specimen, if any, having object values indicative of a greater than average likelihood cellular abnormality based on statistical information derived from a general population with respect to the physical characteristic(s) upon which the object values were calculated. Additionally or alternatively, objects selected for emphasized review may be those objects having object values falling in a top percentage (e.g., top 2-3%), or number (e.g., the top 2-3) of object values for the particular specimen.

In yet another embodiment, a method for prescreening and reviewing cytological specimens includes obtaining and processing image data of a specimen slide in order to identify cellular objects of interest in the specimen, and calculate object values for the identified objects based on one or more of their respective physical attributes, such as shape, size, texture, contrast, nuclear integrated optical density, and nuclear average optical density. The method further includes measuring, based on the image data, one or more attributes of the specimen that are associated with a likelihood of cellular abnormality in a general population. If any of the one or more measured attributes are within a range indicating an above-average likelihood of the presence of abnormal or suspect cells, a relatively high number of objects and/or fields of view are selected for review on the review scope. However, if none of the one or more measured attributes are within such range, a lower number of objects and/or fields of view are selected for review. In embodiments where more than one specimen attribute is measured, a weighed specimen score may be calculated and compared against a range of such possible weighted scores to determine how many objects and/or fields of view to present for review on the review scope. Whatever their number, the fields of view are selected based on the relative object values of objects located in therein, wherein one or more of the objects may also be selected for emphasized review.

By way of non-limiting examples, the measured specimen attribute(s) may include a relative presence of blood cells, an opacity of the specimen slide or of a region thereof, a relative presence of cells having a predetermined nuclear integrated optical density, such as one that is substantially greater than a mean nuclear integrated optical density, or of a standard deviation of a distribution of the nuclear integrated optical densities for identified cellular objects in the specimen. In one embodiment, at least one of the one or more measured attributes is a relative presence of cells in the specimen having physical attributes indicating an above average likelihood of cellular abnormality in a general population, wherein the attributes are selected from the group comprising shape, size, texture, contrast, nuclear integrated optical density, and nuclear average optical density. In another embodiment, at least one of the one or more measured attributes is a relative presence of identified cellular objects in the specimen having object values indicating an above average likelihood of cellular abnormality in a general population.

Other aspects and features of embodiments of the invention will become apparent from the following detailed description of the illustrated embodiments.

### BRIEF DESCRIPTION OF THE DRAWINGS

Embodiments of according to the invention are described and schematically depicted in the following detailed description and the accompanying drawings, in which similar elements in alternate embodiments are given common reference numbers, and in which:

FIG. 1 is a functional schematic block diagram (in plan view) of the main components of an exemplary imaging and review system used for prescreening and reviewing cytological specimen slides;

FIG. 2 illustrates an exemplary slide cassette used to store cytological specimen slides in the system of FIG. 1;

FIG. 3 illustrates an exemplary imager used to acquire images of cytological specimen slides in the system of FIG. 1;

FIG. 4 is a flow chart depicting a method using the system of FIG. 1 for prescreening and reviewing cytological specimen slides;

FIGS. 5A-D are exemplary embodiments of a field of view of a specimen slide presented by a review scope of the system of FIG. 1, the field of view having one or more objects being visually emphasized for review; and

FIG. 6 is a flow chart depicting another method using the system of FIG. 1 for prescreening and reviewing cytological specimen slides.

### DETAILED DESCRIPTION OF THE ILLUSTRATED EMBODIMENTS

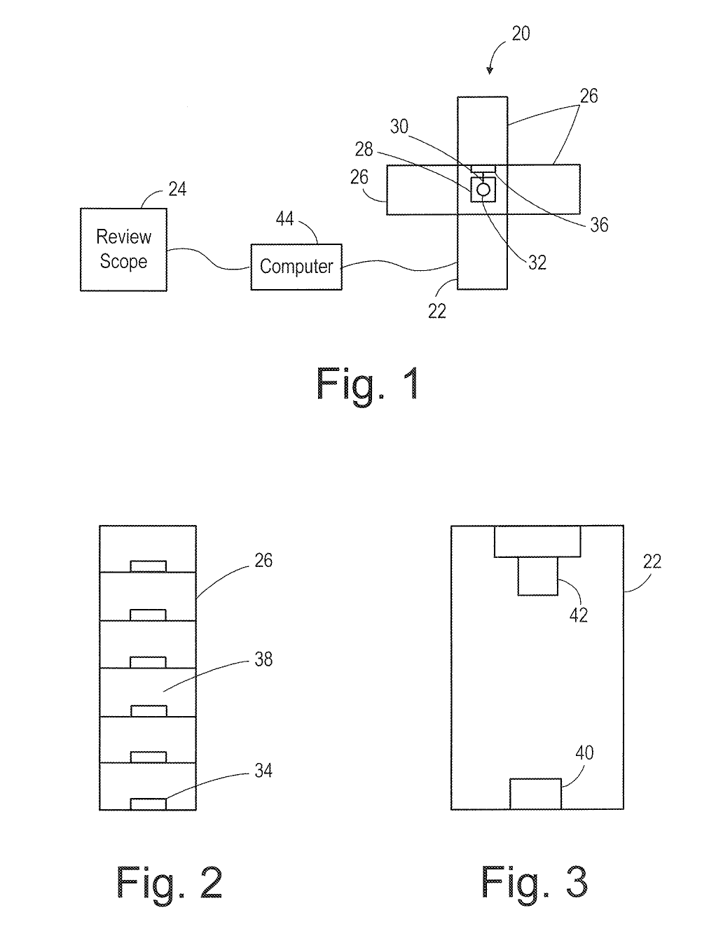

FIG. 1 is a schematic depiction of an exemplary cytological specimen imaging and review system 20, which is shown and described by way of example and not by way of limitation in order to more fully explain the various features and capabilities of embodiments of the invention. It will be appreciated that the inventive concepts disclosed and described herein are applicable to many alternative cytological specimen imaging and review systems.

The imaging and review system 20 includes two main components: an imager 22 and a review scope 24. The system 20 further includes a plurality of slide storage cassettes 26 (three are shown for ease in illustration), wherein the imager 22 and slide cassettes 26 are positioned in a generally circumferential pattern around a slide transport assembly 28. The slide transport assembly 28 includes an extendable arm 30 rotatably coupled to a centrally located vertical track 32. A slide engagement mechanism 36 is located at a distal end of the extendable arm 30, and is configured to readily engage and disengage individual slides 34 retrieved from the slide storage cassettes 26. The slide transport assembly includes one or more drive mechanisms for supplying precise movement of the extendable arm 30, whereby the arm 30 is able to rotate about, extend away from, retract towards, and move axially along, respectively, the vertical track 32. The slide engagement mechanism 36 can thereby reach any point in three-dimensional space, constrained only by the range of radial extension, and range of axial movement along the vertical track 32, and the extendable arm 30. The drive mechanism(s) can be any known and convenient mechanical and/or electromechanical system for controlling movement of the extendable arm 30 and slide engagement mechanism 36, including appropriate motor drives (e.g., piezo-electric actuators, stepper motors, servo motors) and/or encoders, movable and/or flexible joints, and motion actuation hardware. An exemplary slide transport system utilizing a extendable arm for transporting slides between a storage cassette and an imager is shown and described in U.S. patent application Ser. No. 10/008,379, the contents of which are fully incorporated herein by reference for all that they teach and disclose.

An exemplary slide storage cassette 26 for use in the imaging and review system 20 is shown in FIG. 2. The slide storage cassette 26 preferably stores a large number (e.g., at least two dozen) slides 34, which are stacked vertically on individual shelves 38 of the cassette 26. At least one end of the cassette 26 is open to allow access for retrieval and return of the slides 34 from/to the individual shelves 38 by the slide engagement mechanism 36 on the extendable arm 30. In alternate embodiments, the slide storage cassettes 26 and/or shelves 38 may have any number of possible configurations, and can be stacked and/or arranged in any convenient pattern allowing for retrieval and return of the slides 34 by the engagement mechanism 36.

Returning to FIG. 1, the imager 22 can be implemented as any known and convenient imaging system and/or mechanism for capturing discrete, magnified images of specimen samples fixed on the respective slides 34. By way of example, as shown schematically in FIG. 3, the imager 22 preferably includes a slide stage 40, upon which the individual slides 34 are mounted, and a high speed camera 42 positioned to capture images of biological specimens fixed to the slides 34. The slide stage 40 and camera 42 are preferably movable relative to one another so that images of discrete locations on a slide 34 may be obtained. An exemplary imager for use in the imaging and review system 20 is shown and described in the above-incorporated U.S. patent application Ser. No. 10/008,379. Reference is also made to the teachings and disclosure found in U.S. patent application Ser. No. 09/430,198, the contents of which are fully incorporated herein by reference for all that they teach and disclose.

During operation of the imager 22, the slides 34 are retrieved (preferably in a systematic order) one at a time from their respective storage locations (i.e., cassette/shelf 26/38), and positioned on the slide stage 40 by the extendable arm 30. The camera 42 captures images of the specimen slide 34, and the slide 34 is removed from the slide stage 40 and returned to its respective storage location by the extendable arm 30. Preferably, this process is continued until all of the specimen slides 34 have been imaged. The imager 22 is operatively coupled with one or more computers 44 for processing the respective image data. As used herein, “computer” is synonymous with “processor,” and there is no requirement that the computer(s) 44 be separate from the imager 22, e.g., the imager 22 may be provided with an “internal” computer 44 for performing the image processing. In either case, the imager 22 and/or computer(s) 44 are coupled with an appropriate user interface and (optionally) image display (neither shown), as well as a memory having sufficient bandwidth for storing both the system operating software and (at least temporarily) the processed image data from the specimen slides 34. The imager 22 and/or computer(s) 44 may be networked, or stand alone. Further, the image data from the respective specimen slides 34 may be stored in a local memory associated with the imager 22 and/or computer(s) 44, or transmitted to another location or storage medium for real-time and later analysis.

The slide transport assembly 28 is preferably controlled by, or otherwise operatively coupled with, the imager 22 and the computer(s) 44, in order to synchronize movement of the extendable arm 30 with operation of the imager 22 and processing of the image data for each specimen slide 34. In particular, the imager 22 preferably processes the image data acquired for each specimen slide 34 as the images are acquired, wherein cellular objects (both single cells and cell clusters) are distinguished from artifacts to identify objects of interest in the respective specimen. The imager 22 calculates object values for each of the identified cellular objects of interest (typically nuclei, but can be cytoplasms in some embodiments) based on one or more of their respective physical attributes, such as shape, size, texture, contrast, darkness, nuclear integrated optical density, and nuclear average optical density. Fields of view of the respective specimen slide 34 to be presented for review on the review scope 26 are selected by the imager 22 based on the locations of identified objects having object values of greatest relative interest.

The imager 22 also maps the x, y coordinates of the selected fields of view using an algorithm, such as a modified “traveling salesman” algorithm, which determines an efficient viewing route for presenting the fields on the review scope 24. The x, y coordinates of the selected fields of view, plus the routing plan for their viewing, are stored by the system 20, e.g., in a memory associated with the computer(s) 44, for later retrieval by the review scope 24. The review scope 24 is a traditional microscope interface having a motorized stage that presents the selected fields of interest for a respective specimen slide according to the route determined by the image processor. A cytotechnologist views each of the identified fields of interest for a specimen slide 34 and makes decisions about the level of possible cell abnormality, if any. The review scope 24 is preferably configured to allow the cytotechnologist to return to previously viewed fields of interest, and to manually move (and view) locations on the specimen slide 34 that were not necessarily pre-selected by the imager 22. The review scope 24 also provides a means for a reviewing cytotechnologist to electronically mark objects on the specimen slide 34 for further analysis. An exemplary review scope for use in imaging system 20 is shown and described in the above-incorporated U.S. patent application Ser. No. 10/008,379.

Exemplary features and capabilities of embodiments of the imaging and review system 20 in conjunction with methods for its use for prescreening and reviewing cytological specimen slides. It will be appreciated by those skilled in the art that the described embodiments, features and capabilities may be software and/or firmware implemented in, and controlled by, one or more of the image processor 22, review scope 24, and associated computer(s) 44. While the ensuing description and associated drawings are provided primarily in the context of methods for using the system 20 to screen and review cytological specimen slides, it will be appreciated that such description at the same time describes the various features and capabilities of embodiments of the system 20 used to carry out the described methods.

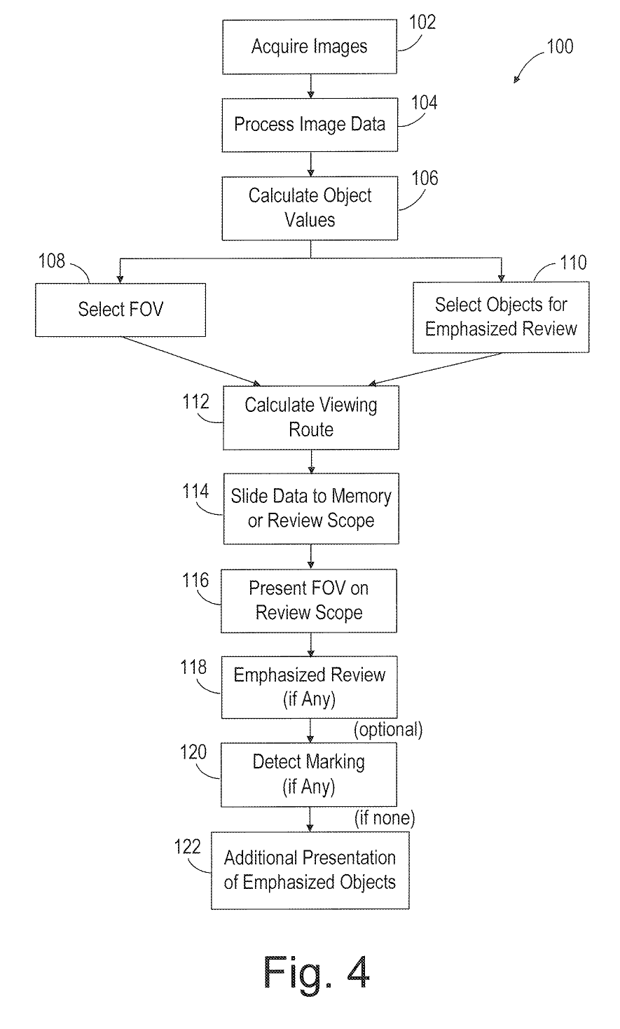

With reference to FIG. 4, in one embodiment, the respective imager 22, review scope 24, and associated computer(s) 44 are configured to perform or to facilitate performance of a method 100 for prescreening and reviewing cytological specimens. The method 100 includes an initial step 102 of using the imager 22 to acquire image data from a cytological specimen fixed to a specimen slide 34. At step 104, the image data is processed, and cellular objects of interest in the specimen are identified based on one or more screening criteria applied by the imager 22. The screening criteria preferably distinguishes cellular objects of interest (both single cell and cell clusters) from artifacts in the specimen, although it is possible that some artifacts may not be screened out, while some cellular objects may themselves be screened out.

At step 106, the imager 22 calculates object values for each of the identified cellular objects of interest based on one or more of their respective physical attributes, such as shape, size, texture, contrast, nuclear integrated optical density, and nuclear average optical density. At step 108, fields of view of the specimen slide to be presented for review on the review scope 24 are selected based on the x, y slide coordinates on the specimen slide 34 of those objects having object values of greatest relative interest. For example, the object values of the identified objects of interest in the specimen may be ranked in an order based on their relative nuclear integrated optical density (for single cell objects), or average optical density (for cluster objects), with the selected fields of view containing the x, y slide coordinates of the relatively highest ranking single cell objects and cluster objects for each specimen, as is done in a present commercial version of the Thin Prep Imaging System from Cytyc Corporation.

At step 110, one or more of the identified objects of interest in the specimen may be further selected for emphasized review, as discussed in greater detail below in conjunction with step 118. By way of non-limiting example, objects selected for emphasized review may be those objects in the specimen, if any, having object values indicative of a greater than average likelihood of cellular abnormality based on statistical information derived from a general population with respect to the physical characteristic(s) upon which the object values were calculated. Additionally or alternatively, objects selected for emphasized review may be those objects having object values falling in a top percentage (e.g., top 2-3%), or number (e.g., the top 2-3) of object values for the particular specimen.

At step 112, the x, y coordinates of the selected fields of view for the specimen slide are mapped using an algorithm that determines an efficient viewing route for presenting the fields on a review scope, such as the modified traveling salesman algorithm employed by the Thin Prep Imaging System from Cytyc Corporation. In some embodiments, the viewing route necessarily takes into account which fields of view contain objects selected for emphasized review, e.g., by presenting the fields of view containing such emphasized objects in a particular order and/or by repeating presentation of such objects two or more discrete times, whether in the same or in differing fields of view. At step 114, the x, y coordinates of the selected fields of view, along with the viewing route, are stored by the system 20 (e.g., in an associated computer 44) for later retrieval by the review scope 24. In alternate embodiments, the information may be transported in real time to the review scope 24 for contemporaneous (or near contemporaneous) review of the specimen slide 34 immediately following completion of the imaging process.

At step 116, the respective specimen slide 34 is mounted on a viewing stage of the review scope 24, and the selected fields of view are presented to a reviewer (normally a cytotechnologist) according to the viewing route. At step 118, objects selected in step 110 for emphasized review are so-emphasized by the review scope 24 in a manner corresponding to the particular embodiment employed by the imaging and review system 20. Such emphasized review may include, for example, an additional presentation on the review scope of the one or more selected objects, whether in the same or different fields of view than when originally presented. Such additional presentation may be automatic or conditioned. For example, one or more objects selected for emphasized review may be presented for additional review only if no objects were marked for subsequent analysis during an initial review of a specimen slide. Alternatively and/or additionally, such emphasized review of a selected one or more objects may be provided by highlighting or otherwise visually emphasizing the object(s) when they are presented for viewing on the review scope 24.

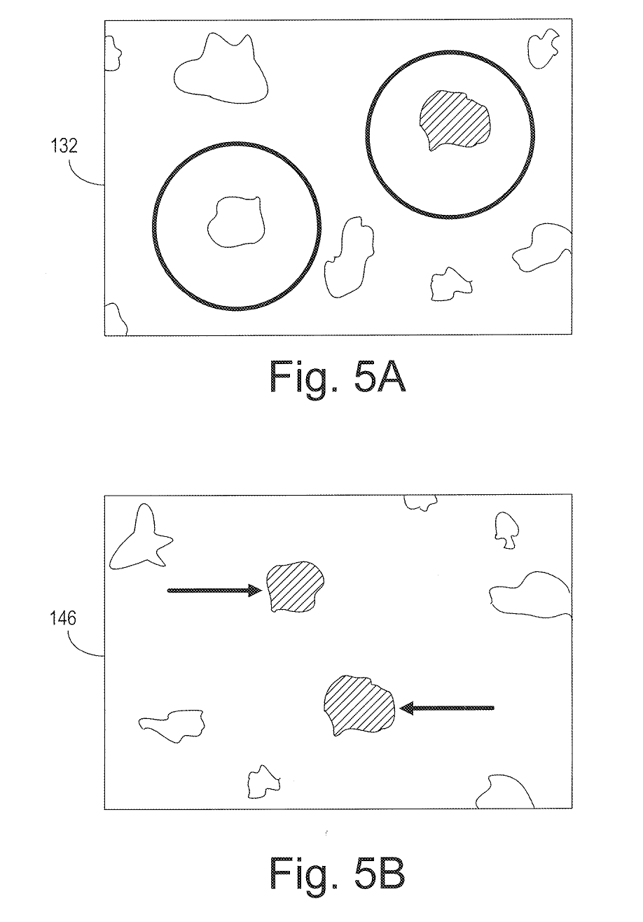

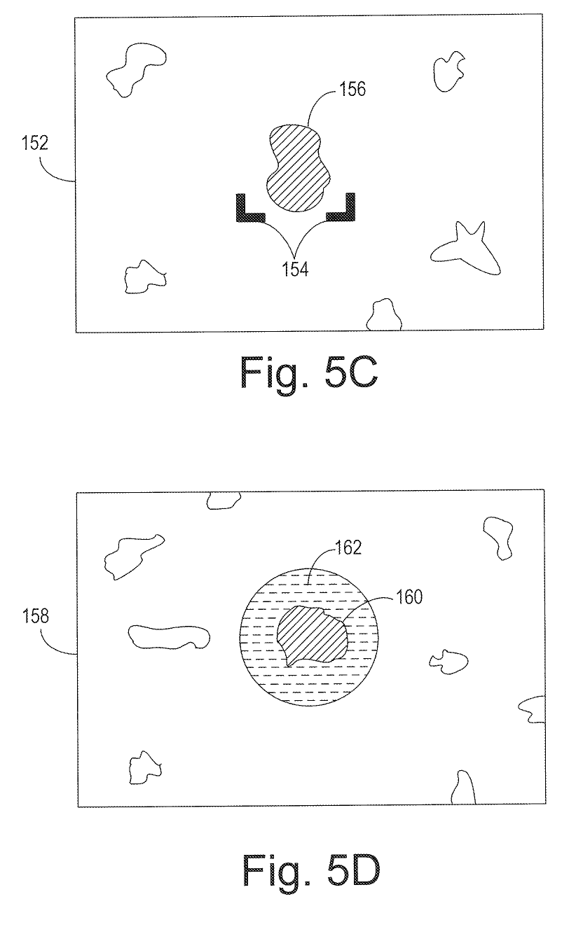

By way of one example, FIG. 5A depicts a field of view 132 including emphasized objects of interest 134 and 136 that appear circled to a cytotechnologist observing the field of view. In particular, images of the circles 138 and 140 are added by the review scope 24 to the field of view 132 to circumscribe the locations of the respective objects 134 and 136 in a well known manner for providing multiple visual image inputs to a field of view on a review scope 24. The particular example of two circled objects is by way of non-limiting illustration, and frequently only a single object would be circled (i.e., highlighted), although it can also be more than two objects. By way of another example, images of arrows 142 and 144 are added in a field of view 146 shown in FIG. 5B, wherein the arrows 142 and 144 are oriented pointing to respective objects 148 and 150 to be emphasized. Again, the particular example of two objects being pointed to by the arrows 142 and 144 is by way of non-limiting illustration, and frequently only a single object would be pointed at (i.e., highlighted), although it can also be more than two objects. By way of still further examples, FIG. 5C depicts a field of view 152, in which an image of a pair of alignment brackets 154 has been added to “frame” respective an emphasized object 156; and FIG. 5D depicts a field of view 158 in which an emphasized object 160 has been highlighted with additional backing illumination 162 comprising an “emphasizing” color or tint.

It will be appreciated that the examples illustrated in FIGS. 5A-5D are just some of the ways that the review scope 24 can emphasize the review of selected objects of interest, and there are many other various ways that individual objects of interest, or entire fields of view, may be visually highlighted or emphasized for ease in detection and analysis by the reviewer. For example, an audio sound (e.g., a soft buzzer) or mechanical vibration (e.g., of a hand-held controller) may be activated whenever a field of view is presented on the review scope 24 including one or more objects to be emphasized. By way of still further examples, a field of view containing one or more objects to be emphasized may be given a highlighted boundary, or may be preceded by a flashing light or indicator shown through the lens objective of the review scope. In some embodiments, the objects to be emphasized, if any, or the fields of view containing such objects on a given specimen slide 34 are emphasized when initially presented for review. In other embodiments, the objects and/or fields of view are visually emphasized only during a second presentation for review, whether in the same or in a different field of view. In still other embodiments, the selected objects and/or fields of view are emphasized each time they are presented for review. In yet further embodiments, no particular emphasis is given to the individual objects and/or fields of view, except that those objects and/or fields of view to be emphasized are presented for review more than once during review of the respective specimen slide 34. In still further embodiments, the review scope increases the level of magnification of objects to be emphasized, e.g., from a standard 10× up to as much as to 40× for emphasized review.

As noted above, the review scope 24 preferably includes a user interface for marking cellular objects on the specimen slide for further review. Since, by definition, a false positive does not result if any objects are marked for further analysis during review of a specimen slide, in some embodiments of the invention, no objects are initially emphasized when presented for review, and instead, at optional step 120, the review scope detects whether any cellular object(s) were marked for further review during review of the specimen slide 34. If, after a review of all of the presented fields of view, no object was marked, at step 122, one or more previously presented identified objects of interest on the specimen slide 34 are presented for an additional review on the review scope 24, whether in the same or in a differing field of view as when the one or more objects were previously presented. As part of step 122, such objects presented for repeated review may (optionally) be visually (or audibly or mechanically) emphasized, as described above.

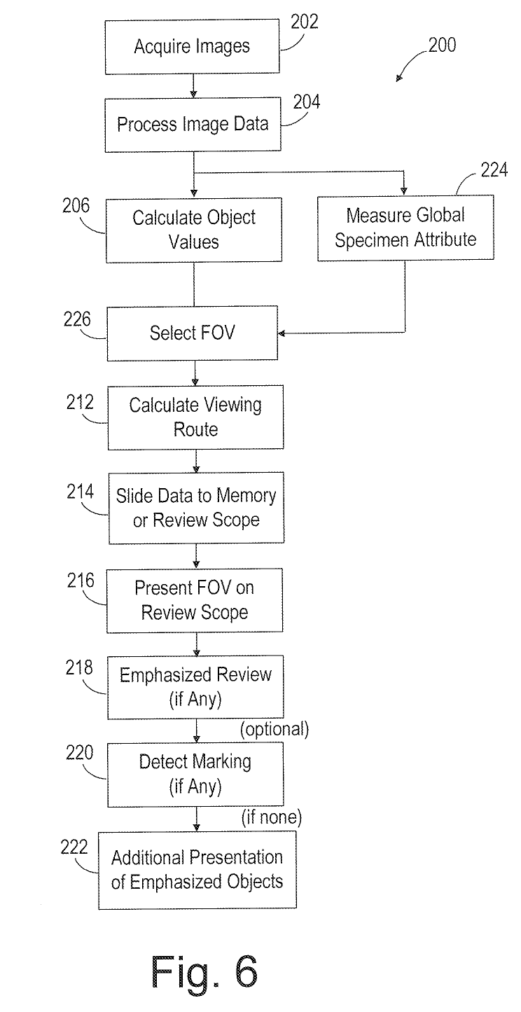

Referring to FIG. 6, another method 200 for prescreening and reviewing cytological specimens using the imaging and review system 20, generally includes substantially the same initial steps as performed in method 100, including: obtaining images of a cytological specimen fixed to a specimen slide (step 202); processing the images to identify cellular objects of interest in the specimen (step 204); and calculating object values for identified cellular objects based on one or more of their physical attributes (step 206). In method 200, however, an additional step 224 is performed in which the imager 22 further measures, based on the image data, one or more attributes of the specimen slide 34 that are associated with a likelihood of cellular abnormality in a general population.

At step 226, if any of the one or more measured attributes are within a range indicating an above-average likelihood of the presence of abnormal or suspect cells, the imager 22 selects a relatively high number of objects and/or fields of view for review on the review scope 24. However, if none of the one or more measured attributes are within such range, the imager 22 selects a lower number of objects and/or fields of view for review on the review scope 24. In embodiments where more than one specimen attribute is measured, a weighed specimen score may be calculated and compared against a range of such possible weighted scores to determine how many objects and/or fields of view to present for review on the review scope. Whatever their number, the imager selects the fields of view based on the relative object values of objects located in therein, wherein one or more of the objects may also be selected for emphasized review.

By way of non-limiting examples, the measured specimen attribute(s) may include a relative presence of blood cells, an opacity of the specimen slide or of a region thereof, a relative presence of cells having a predetermined nuclear integrated optical density, such as one that is substantially greater than a mean nuclear integrated optical density, or of a standard deviation of a distribution of the nuclear integrated optical densities for identified cellular objects in the specimen. In one embodiment, at least one of the one or more measured attributes is a relative presence of cells in the specimen having physical attributes indicating an above average likelihood of cellular abnormality in a general population, wherein the attributes are selected from the group comprising shape, size, texture, contrast, nuclear integrated optical density, and nuclear average optical density. In another embodiment, at least one of the one or more measured attributes is a relative presence of identified cellular objects in the specimen having object values indicating an above average likelihood of cellular abnormality in a general population.

The method 200 includes substantially the same further steps as performed in method 100. In particular, at step 218, one or more of the identified objects of interest in the specimen may be further selected for emphasized review based on the same criteria as described above with respect to step 110 of method 100. At step 212, the x, y coordinates of the selected fields of view for the specimen slide 34 are mapped using an algorithm that determines an efficient viewing route for presenting the fields on a review scope, wherein the viewing route may take into account which fields of view contain objects selected for emphasized review, as described above regarding step 112 of method 100. At step 214, the x, y coordinates of the selected fields of view, along with the viewing route and the measured attribute information for the specimen slide 34, are stored by the system 20 (e.g., in an associated computer 44) for later retrieval by the review scope 24. In alternate embodiments, the information may be transported in real time to the review scope 24 for contemporaneous (or near contemporaneous) review of the specimen slide 34 immediately following completion of the imaging process.

At step 216, the fields of view are presented for review on the review scope 24, and at step 218, those objects (if any) selected in step 226 for emphasized review are so-emphasized by the review scope 24 in a manner corresponding to the particular embodiment employed by the imaging and review system 20. Such emphasized review may take the same forms as described above with respect to step 118 of method 100, including, for example, an additional presentation on the review scope of the one or more selected objects, whether in the same or different fields of view than when originally presented, and whether such additional presentation is automatic or conditioned. For example, one or more objects selected for emphasized review may be presented for additional review only if a measured attribute (from step 224) of the specimen slide indicates an above-average likelihood of the presence of abnormal or suspicious cells. And again, such emphasized review of a selected one or more objects may also include highlighting or otherwise visually emphasizing the object(s) when they are presented for viewing on the review scope 24.

As was also the case with method 100, since a false positive does not result if any objects are marked for further analysis during review of a specimen slide 34 on the review scope 24, in some embodiments of the invention, no objects are initially emphasized when presented for review in method 200, and instead, at optional step 220, the review scope detects whether any cellular object(s) were marked for further review during review of the specimen slide 34. If, after a review of all of the presented fields of view, no object was marked, at step 222, one or more previously presented identified objects of interest on the specimen slide 34 are presented for an additional review on the review scope 24, whether in the same or in a differing field of view as when the one or more objects were previously presented. As part of step 222, such objects presented for repeated review may (optionally) be visually (or audibly or mechanically) emphasized, as described above.

The invention has been described with reference to particular embodiments and features thereof. It will be apparent, however, that various modifications and changes may be made to the illustrated and described embodiments without departing from the scope of the invention, which is not to be limited except as set forth in the appended claims. The specification and drawings are, accordingly, to be regarded in an illustrative, rather than restrictive, sense.

What is claimed:

1. A system for the prescreening and reviewing of cytological specimen slides, comprising:
a review scope;
an imager configured for acquiring and processing image data of a cytological specimen fixed to a specimen slide, wherein the imager
identifies cellular objects of interest in the specimen based on the image data and a screening criteria, the screening criteria distinguishing cellular objects from artifacts,
calculates object values for identified cellular objects based on one or more of their respective physical attributes ascertained from the image data,
selects fields of view of the specimen slide to be reviewed on the review scope based on relative object values of objects of interest located in the respective fields of view, and
selects one or more objects of interest located in the selected fields of interest for emphasized review on the review scope.

2. The system of claim 1, the review scope comprising a user interface for marking cellular objects on the specimen slide for further analysis, wherein the review scope is configured to
detect whether any object on the specimen slide was marked for further analysis during a review of the selected fields of view, and
if no object was marked on the specimen slide, present the one or more objects selected for emphasized review for additional review.

3. The system of claim 2, wherein the one or more objects selected for emphasized review are visually emphasized as they are presented for additional review on the review scope.

4. The system of claim 1, wherein the one or more objects selected for emphasized review have object values indicative of a greater than average likelihood cellular abnormality based on statistical information derived from a general population with respect to the one or more physical attributes upon which the object values were calculated.

5. The system of claim 4, wherein the one or more physical attributes are selected from the group comprising:
shape,
size,
texture,
contrast,
darkness,
nuclear integrated optical density, and
nuclear average optical density.

6. The system of claim 1, wherein the one or more objects selected for emphasized review have object values that are within a specified top percent of object values of the specimen slide.

7. The system of claim 6, wherein the one or more objects selected for emphasized review have object values that are within a top three percent of object values of the specimen slide.

8. The system of claim 1, wherein the one or more objects selected for emphasized review have object values that are within a specified top number of object values of the specimen slide.

9. The system of claim 8, wherein the one or more objects selected for emphasized review have object values that are within the top five object values of the specimen slide.

10. The system of claim 1, wherein the one or more objects selected for emphasized review are visually emphasized as they are presented on the review scope.

11. The system of claim 1, wherein visual markers are displayed to emphasize the one or more objects selected for emphasized review as they are presented on the review scope.

12. The system of claim 1, wherein the one or more objects selected for emphasized review are emphasized by an audio signal associated with their presentation on the review scope.

13. The system of claim 1, wherein the one or more objects selected for emphasized review are emphasized by a mechanical vibration associated with their presentation on the review scope.

14. The system of claim 1, wherein the one or more objects selected for emphasized review are emphasized by increasing their magnification on the review scope.

15. A system for assisting in the prescreening and reviewing of cytological specimen slides, comprising:
an imager for acquiring and processing image data of a cytological specimen fixed to a specimen slide, wherein the imager
identifies cellular objects of interest in the specimen based on the image data and a screening criteria, the screening criteria distinguishing cellular objects from artifacts,
calculates object values for identified cellular objects based on one or more of their respective physical attributes ascertained from the image data,
measures an attribute of the specimen linked with a likelihood of cellular abnormality in a general population, and
selects a first number of fields of view of the specimen slide to be reviewed on a review scope if the measured attribute is within a specified range, and otherwise selects a second number of fields of view of the specimen slide to be reviewed on a review scope, wherein the selected fields of view are based on relative object values of identified objects of interest located in the respective fields of view.

16. The system of claim 15, wherein the measured attribute is selected from the group comprising:
a relative presence of blood cells,
an opacity of the specimen slide,
an opacity of a region of the specimen slide,
a relative presence of cells having a nuclear integrated optical density substantially greater than a mean nuclear integrated optical density for the specimen,
a relative presence of cells having a nuclear integrated optical density greater than a predetermined level,
a relative presence of cells having a nuclear integrated optical density greater than one standard deviation of a distribution of the nuclear integrated optical densities for identified cellular objects in the specimen,
a relative presence of cells having attributes indicating an above average likelihood of cellular abnormality in a general population, and
a relative presence of identified cellular objects having object values indicating an above average likelihood of cellular abnormality in a general population.

17. The system of claim 16, wherein the attributes indicating an above average likelihood of cellular abnormality in a general population are selected from the group comprising:
shape,
size,
texture,
contrast,
darkness,
nuclear integrated optical density, and
nuclear average optical density.

18. The system of claim 15, wherein the measured attribute is a relative presence of identified cellular objects having object values indicating an above average likelihood of cellular abnormality in a general population.

19. The system of claim 15, wherein the imager further selects one or more objects of interest located in the selected fields of interest for emphasized review on the review scope.

20. A method for screening and reviewing cytological specimens, comprising:
acquiring image data of a cytological specimen fixed to a specimen slide;
identifying, based on the image data and on a screening criteria, cellular objects of interest in the specimen, wherein the screening criteria distinguishes cellular objects from artifacts;
calculating object values of identified cellular objects based on one or more of their respective physical attributes;
presenting fields of view of the specimen slide on a review scope based on relative object values of identified objects of interest located in the respective fields of view; and
emphasizing one or more objects in the presented fields of view on the review scope.

21. The method of claim 20, further comprising
detecting whether any object on the specimen slide was marked for further analysis during a review of the selected fields of view on the review scope, and
if no object was marked on the specimen slide, presenting one or more previously presented objects for additional review on the review scope.

22. The method of claim 20, wherein emphasis of the one or more objects in the presented fields of view on the review scope is accomplished by one or more of visually, audibly, and mechanically.

23. The method of claim 20, wherein the one or more emphasized objects have object values indicative of a greater than average likelihood cellular abnormality based on statistical information derived from a general population with respect to the one or more physical attributes upon which the object values were calculated, wherein the one or more physical attributes are selected from the group comprising:
shape,
size,
texture,
contrast,
darkness,
nuclear integrated optical density, and
nuclear average optical density.

24. The method of claim 20, wherein the one or more emphasized objects have object values that are within a specified top percent of object values of the specimen slide.

25. The method of claim 20, wherein the one or more emphasized objects have object values that are within a specified top number of object values of the specimen slide.

26. The method of claim 20, wherein visual markers are used to emphasize the one or more objects.

27. The method of claim 20, wherein the one or more emphasized objects are emphasized by being presented more than one for review on the review scope, whether in the same or in differing fields of view.

28. The method of claim 20, wherein the one or more emphasized objects are emphasized by increasing their magnification on the review scope.

29. A method for prescreening and reviewing cytological specimens, comprising:
acquiring and processing image data of a cytological specimen fixed to a specimen slide, wherein processing the image data includes
identifying cellular objects of interest in the specimen,
calculating object values for the identified cellular objects based on one or more of their respective physical attributes,
measuring an attribute of the specimen linked with a likelihood of cellular abnormality in a general population, and
selecting a first number of fields of view of the specimen slide to be reviewed on a review scope if the measured attribute is within a specified range, and otherwise selecting a second number of fields of view of the specimen slide to be reviewed on a review scope, wherein the selected fields of view are based on relative object values of identified objects of interest located in the respective fields of view.

30. The method of claim 29, wherein the measured attribute is selected from the group comprising:
a relative presence of blood cells,
an opacity of the specimen slide,
an opacity of a region of the specimen slide,
a relative presence of cells having a nuclear integrated optical density substantially greater than a mean nuclear integrated optical density for the specimen,
a relative presence of cells having a nuclear integrated optical density greater than a predetermined level,
a relative presence of cells having a nuclear integrated optical density greater than one standard deviation of a distribution of the nuclear integrated optical densities for identified cellular objects in the specimen,
a relative presence of cells having attributes indicating an above average likelihood of cellular abnormality in a general population, and
a relative presence of identified cellular objects having object values indicating an above average likelihood of cellular abnormality in a general population.

31. The method of claim 29, further comprising emphasizing one or more objects in the presented fields of view on the review scope.
